(19) United States
(12) Patent Application Publication
(10) Pub. No.: US 2016/0069766 A1
(43) Pub. Date: Mar. 10, 2016

(54) DETERMINING INLET MANIFOLD PRESSURE OF ENGINE

(71) Applicant: Caterpillar Inc., Peoria, IL (US)

(72) Inventor: Balajee K. Asokan, Chennai (IN)

(73) Assignee: Caterpillar Inc., Peoria, IL (US)

(21) Appl. No.: 14/940,180

(22) Filed: Nov. 13, 2015

(51) Int. Cl. G01L 23/24; G01M 15/09; G01L 19/08

(52) U.S. Cl. CPC G01L 23/24; G01L 19/08; G01M 15/09

(57) ABSTRACT

A method for determining inlet manifold pressure of an engine includes receiving a first set of inputs form a first sensor. The first set of inputs being indicative of speed of the engine. The method includes receiving a second set of inputs from a second sensor. The second set of inputs being indicative of rate of fuel supplied to the engine. The method includes generating a three dimensional (3D) map via a control module based on the first set of inputs, the second set of inputs and a data indicative of a set of inlet manifold pressures. The data indicative of the set of manifold pressures correspond to historical data generated based on the first set of inputs and the second set of inputs. The method includes obtaining a request to determine inlet manifold pressure. Further, the inlet manifold pressure is determined from the 3D map based on the request.

### TECHNICAL FIELD

The present disclosure relates to an inlet manifold of an engine, and more particularly to a method for determining inlet manifold pressure of the engine.

### BACKGROUND

Intake manifold pressure is an important factor for extracting desired efficiency from an engine. In particular, many aspects of the engine can be improved with variation in the inlet manifold pressure. For example, inlet manifold pressure data can be used to determine combustion timing, to detect misfire in engine cylinder, and also determine peak cylinder pressure. Typically, in order to determine the inlet manifold pressure, certain physical sensors, referred to as manifold absolute pressure (MAP) sensors, are employed. These physical MAP sensors often measure the pressure at locations they are mounted. However, the physical MAP sensors do not provide the pressure values at locations distant from a point at which they are mounted. In addition, the physical MAP sensors need to be associated with hardware to realize the outputs and, therefore, are costly. Further, any failure of the physical MAP sensor may render the hardware inoperable. With the development of technology, conventionally, virtual sensors are employed for determining the intake manifold pressure. The virtual sensors provide the intake manifold pressure based on one or more input parameters associated with the engine.

U.S. Pat. No. 6,178,749, hereinafter referred to as the '749 patent, discloses a method of determining intake manifold pressure and intake manifold mass airflow set point as a function of current engine speed and requested fueling rate. The method of the '749 patent further includes modifying the set points by a transient governor to generate modified set points as a function of intake manifold pressure and intake manifold mass airflow, respectively. The method further includes feeding the modified set points to a controller to drive a turbocharger and EGR valve to the desired set points, thereby maximizing the amount of fresh air admitted to the engine during transient operation. As such, the '749 patent is directed toward determining intake manifold pressure by complex mathematical relations and therefore requires large computation time.

### SUMMARY OF THE DISCLOSURE

In one aspect of the present disclosure, a method for determining inlet manifold pressure of an engine is disclosed. The method includes receiving a first set of inputs from a first senor, the first set of inputs being indicative of speed of the engine. The method includes receiving a second set of inputs from a second sensor, the second set of inputs being indicative of rate of fuel supplied to the engine. The method further includes generating a three dimensional map via a control module based on the first set of inputs, the second set of inputs, and a data indicative of set of inlet manifold pressures. Each value of the set of inlet manifold pressure is associated with a value of speed of the engine and a value of rate of fuel supplied to the engine. The data indicative of the set of manifold pressures correspond to historical data generated based on the first set of inputs and the second set of inputs. Upon generating the three dimensional map, the method includes obtaining a request to determine inlet manifold pressure at a desired engine speed and at a desired rate of fuel supplied to the engine. The method further includes determining, based on the request, the inlet manifold pressure at the desired engine speed and at the desired rate of fuel supplied to the engine, interpolated form the 3D map.

Other features and aspects of this disclosure will be apparent from the following description and the accompanying drawings.

### BRIEF DESCRIPTION OF THE DRAWINGS

FIG. 1 is a schematic block diagram of air and fuel induction system of an engine, according to an embodiment of the present disclosure;

FIG. 2 is an exemplary schematic representation of a three-dimensional map derived based on fuel rate, engine speed, and intake manifold pressure;

FIG. 3 is a flow chart depicting a method for determining the inlet manifold pressure of the engine; and

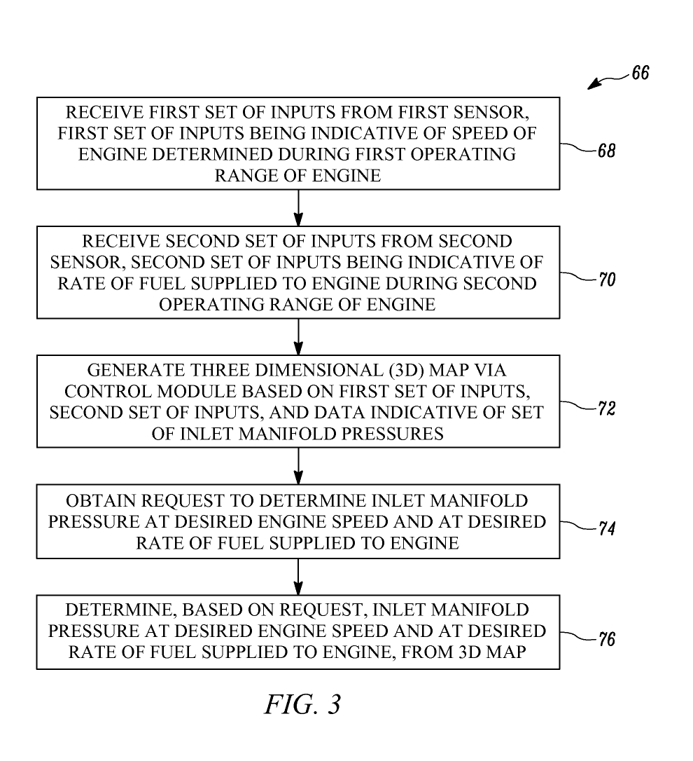

FIG. 4 is an exemplary two-dimensional plot derived from the intake manifold pressures values determined at various intervals of time.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

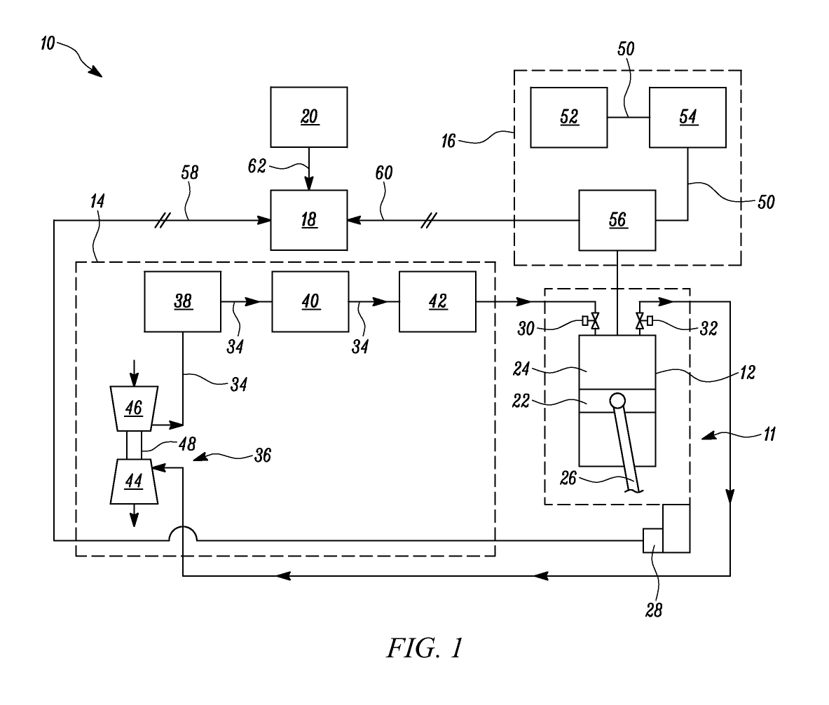

FIG. 1 illustrates an air and fuel induction system 10 of an engine 11, according to an embodiment of the present disclosure. For the purpose of this disclosure, the engine 11 is described as a four-stroke compression ignition engine. However, it will be understood by a person skilled in the art that the engine 11 may be any other type of combustion engine, such as a gasoline or gaseous fuel powered engine. The engine 11 includes a cylinder 12, an air supply module 14 for supplying air to the cylinder 12, a fuel supply module 16 for supplying fuel to the cylinder 12, a control module 18, and a data repository 20. Although FIG. 1 illustrates a single cylinder 12, it will be appreciated that the engine 11 may include a number of cylinders disposed in an in-line configuration, a V-configuration, or in any other suitable configuration as may be known to the person skilled in the art. The engine 11 may alternatively include other components and is not limited to those recited herein.

Further, a piston 22 is slidably disposed within the cylinder 12 to reciprocate between a top-dead-center position and a bottom-dead-center position, and a cylinder head (not shown) may be associated with each cylinder 12. A volume within the cylinder 12, the piston 22, and the cylinder head defines a combustion chamber 24. The piston 22 is connected to a crankshaft (not shown) via a connecting rod 26. The piston 22 reciprocates within the cylinder 12, thereby rotating the crank shaft to provide mechanical power to external devices, such as a transmission unit. The engine 11 includes a first sensor 28 to measure speed of the engine 11. In one example, the first sensor 28 may be coupled to the crankshaft of the engine 11. The speed of the engine 11 is commonly expressed in terms of crankshaft revolutions per minute (RPM).

Further, the air supply unit 14 is provided to supply air to the cylinder 12. The cylinder 12 also includes an inlet valve 30 and an exhaust valve 32. The air supply unit 14 is operably connected to the inlet valve 30 of the cylinder 12. The inlet valve 30 regulates admission of the air into the cylinder 12. It will be understood to the person skilled in the art that the inlet valve 30 may be a cam operated valve. The air supply unit 14 further includes a turbocharger 36 to increase the engine's power output, a throttle valve 38 to control flow of air into the cylinder 12, an after-cooler 40 to control temperature of the air, and an inlet manifold 42. The air supply unit 14 may alternatively include other components and is not limited to those recited herein.

The turbocharger 36 is provided to supply compressed air into the inlet manifold 42 to be finally drawn into the combustion chamber 24. The turbocharger 36 includes a turbine 44 and a compressor 46. The turbine 44 receives exhaust gas from the engine 11. The turbine 44 is mechanically coupled to the compressor 46 via a shaft 48. As such, the turbine 44 converts kinetic energy of the exhaust gases into mechanical energy to drive the compressor 46 via the shaft 48.

The throttle valve 38 is positioned in a passageway 34 between the turbocharger 36 and the after-cooler 40. The throttle valve 38 controls a flow of the compressed air from the turbocharger 36 to the inlet manifold 42, thereby regulating a pressure of compressed air at the inlet manifold 42, hereinafter referred to as the inlet manifold pressure. In one example, the throttle valve 38 may be electronically operated by an electronic control unit (ECU). The after-cooler 40 regulates the temperature of the compressed air being supplied into the cylinder 12 through the inlet manifold 42. The fuel supply unit 16 is provided to supply the fuel to the cylinder 12. The fuel supply unit 16 includes a fuel tank 52 to store fuel, a fuel pump 54, and a second sensor 56. The second sensor 56 is disposed along a fuel line 50 downstream of the fuel pump 54. The second sensor 56 is configured to measure a flow rate of the fuel being supplied to the cylinder 12.

Further, the control module 18 is communicatively coupled to the first sensor 28, the second sensor 56, and the data repository 20. In an example, the control module 18 may be a processor that includes a single processing unit or a number of units, all of which include multiple computing units. The explicit use of the term ‘processor’ should not be construed to refer exclusively to hardware capable of executing a software application. Rather, in this example, the control module 18 may be implemented as one or more microprocessor, microcomputers, digital signal processor, central processing units, state machine, logic circuitries, and/or any device that is capable of manipulating signals based on operational instructions. Among the capabilities mentioned herein, the control module 18 may also be configured to receive, transmit, and execute computer-readable instructions. Further, in one example, the data repository 20 may be integral to the control module 18. In another example, the data repository 20 may be a separate module, as shown in FIG. 1.

The control module 18 is configured to receive a first set of inputs from the first sensor 28 via a first sensing path 58. The first set of inputs is indicative of the speed of the engine 11. The first set of inputs includes values of speed of the engine 11 determined at predetermined time intervals, for example, ten minutes. In other words, the speed of the engine 11 can be determined every ten minutes while the throttle valve 38 operates the engine 11. In addition to receiving the first set of inputs, the control module 18 is also configured to receive a second set of inputs from the second sensor 56 via a second sensing path 60. The second set of inputs is indicative of rate of the fuel supplied to the engine 11. More specifically, the second set of inputs is indicative of the flow rate of the fuel drawn into the cylinder 12.

Further, the control module 18 is configured to receive data from the data repository 20 via a communication channel 62. The data repository 20 stores data indicative of a set of inlet manifold pressures. The data indicative of the set of manifold pressures corresponds to historical data generated based on the first set of inputs and the second set of inputs. Each value of the inlet manifold pressure is associated with a value of speed of the engine 11 and a value of rate of fuel supplied to the engine 11. In one example, each value of the set of inlet manifold pressures is obtained from a test bench (not shown) with respect to the value of speed of the engine 11 and the value of the flow rate of the fuel supplied to the engine 11. Test bench may be understood as an environment equipped with multiple devices to measure, analyze, and ascertain correctness of various values, for example, the inlet manifold pressure in this case.

The control module 18 receives the data indicative of the set of inlet manifold pressures based on the first set of inputs and the second set of inputs. In one example, the set of inlet manifold pressures stored in the data repository 20 may be discrete values. For instance, the data repository 20 may include values of inlet manifold pressure determined at certain time intervals. Accordingly, in an example, the inlet manifold pressures may have values in multiples of fifty, such as 50 bar pressure, 100 bar pressure, 150 bar pressure, and so on. In such conditions, the control module 18 is configured to perform interpolation for determining values of inlet manifold pressure for a complete range of values, such as a range of 50 bar pressure to 300 bar pressure. Based on the interpolated values, the control module 18 is configured to plot a three dimensional (3D) map based on the values obtained by performing the interpolation technique using a model building tool.

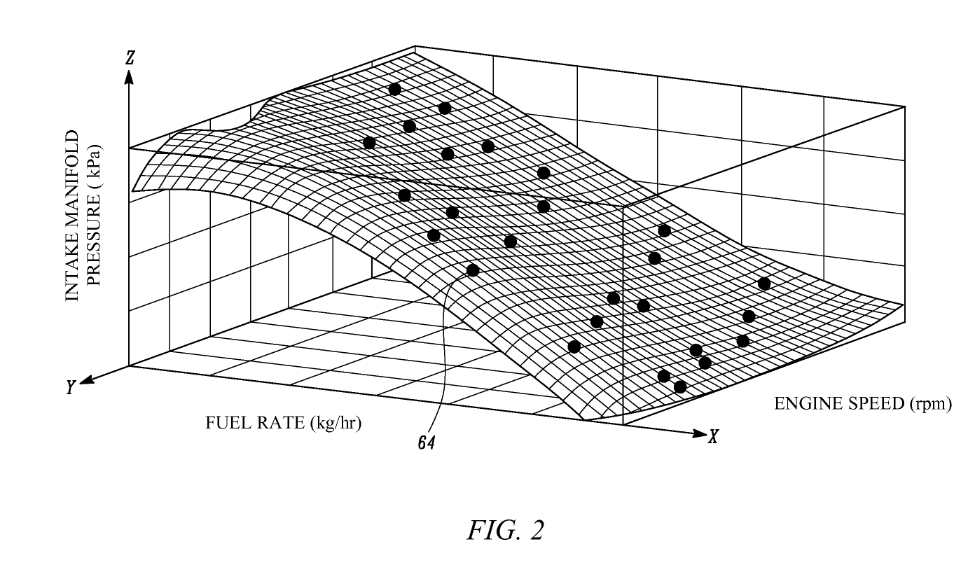

FIG. 2 shows the 3D map plotted with the values of intake manifold pressure, values of the speed of the engine 11, and values of the rate of fuel supplied to the engine 11. As shown in FIG. 2, the fuel rate, the speed of the engine 11, and the inlet manifold pressures are plotted along an X-axis, a Y-axis, and a Z-axis, respectively. In one example, the control module 18 is configured to obtain a request from an operator to determine a value of inlet manifold pressure at the desired engine speed of, for example, 850 rpm and the desired flow rate of, for example, 100 kg/hr. The control module 18 determines a corresponding inlet manifold pressure data at the given engine speed & fuel flow rate value. A data point 64 as shown in FIG. 2 is a representation of inlet manifold pressure as 155 kPa which corresponds to the desired engine speed and the desired flow rate given.

### INDUSTRIAL APPLICABILITY

The present disclosure relates to the method 66 for determining inlet manifold pressure of the engine 11 at a desired speed of the engine 11 and at a desired rate of fuel supplied to the engine 11. In addition, the method 66 provides value of the inlet manifold pressure without aid of an inlet manifold pressure sensor (IMAP sensor).

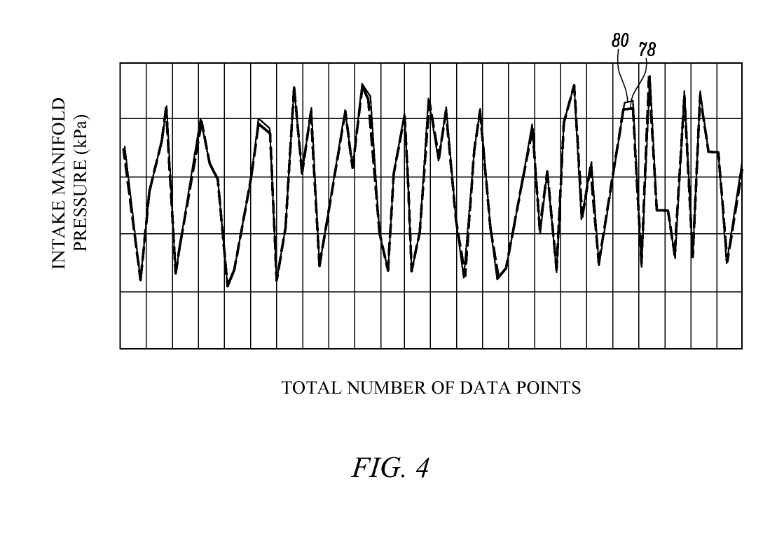

FIG. 4 illustrates a flow chart depicting a method 66 for determining inlet manifold pressure of the engine 11. At step 68, the method 66 includes receiving the first set of inputs from the first sensor 28. The first set of inputs is indicative of the speed of the engine 11. In addition, the control module 18, in communication with the first sensor 28, receives inputs regarding the speed of the engine 11.

At step 70, the method 66 includes receiving the second set of inputs from the second sensor 56. The second set of inputs is indicative of the rate of fuel supplied to the engine 11. The second sensor 56, in communication with the fuel supply unit 16, measures the flow rate of the fuel being supplied to the cylinder 12 of the engine 11. Further, at step 72, the method 66 includes generating the three dimensional (3D) map via the control module 18. The 3D map is generated based on the first set of inputs, the second set of inputs, and the data indicative of the set of inlet manifold pressures. The control module 18 is configured to interpolate values of the inlet manifold pressures in cases where the historical data stored in the data repository 20 is in a discrete manner.

Furthermore, at step 74, the method 66 includes obtaining the request from the operator to determine the inlet manifold pressure at the desired engine speed and at the desired rate of fuel supplied to the engine 11. In an example, the operator may input the desired speed of the engine 11 and the desired rate of fuel in a user interface, such as a computer system, that is communicatively coupled to the control module 18. Accordingly, at step 78, the method 66 includes determining, based on the request, the inlet manifold pressure at the desired speed of the engine 11 and at the desired rate of fuel supplied to the engine 11 interpolated from the 3D map generated by the control module 18.

With the present disclosure, the method 66 offers a simple and easy technique for determining inlet manifold pressure of the engine 11. In addition, the method 66 offers a convenient technique for determining the inlet manifold pressure in the engine 11 without the aid of an inlet manifold pressure sensor (IMAP sensor). The method 66 generates the 3D map that is used as the virtual sensor for determining the inlet manifold pressure in the engine 11 for the desired speed of the engine 11 and at the desired rate of fuel supplied to the engine 11. As such, the method 66 of the present disclosure assists in minimizing cost of operations, which otherwise was high due to presence of multiple IMAP sensors. Further, the method 66 offers a flexible technique for determining inlet manifold pressure that is applicable to any type of engine known in the art. Therefore, the method 66 is simple, effective, easy to use, economical, and time-saving.

FIG. 4 illustrates a two-dimensional plot for comparing values of the intake manifold pressures obtained from the IMAP sensors with that obtained by the 3D map generated by the control module 18. As shown in FIG. 4, the value of inlet manifold pressures determined by the 3D map is superimposed on the values of inlet manifold pressure obtained from the IMAP sensor. The two dimensional plot clearly illustrates a first graph 78 derived from values of the inlet manifold pressure from the 3D map almost coincide with a second graph 80 derived from values obtained from the IMAP sensor, thereby showing the accuracy of values if inlet manifold pressures determined from the 3D map. Therefore, the virtual sensor eliminates the need of the IMAP sensor in the engine 11 for determining the inlet manifold pressure, thereby eliminating any possibility of any malfunctioning or operational failure of the physical IMAP sensor.

While aspects of the present disclosure have been particularly shown and described with reference to the embodiments above, it will be understood by those skilled in the art that various additional embodiments may be contemplated by the modification of the disclosed remote operating station without departing from the spirit and scope of what is disclosed. Such embodiments should be understood to fall within the scope of the present disclosure as determined based upon the claims and any equivalents thereof.

What is claimed is:

1. A method for determining inlet manifold pressure of an engine, the method comprising:
receiving a first set of inputs from a first sensor, the first set of inputs being indicative of speed of the engine;
receiving a second set of inputs from a second sensor, the second set of inputs being indicative of rate of fuel supplied to the engine;
generating a three dimensional (3D) map via a control module based on the first set of inputs, the second set of inputs, and a data indicative of a set of inlet manifold pressures, wherein each value of the set of inlet manifold pressure is associated with a value of speed of the engine and a value of rate of fuel supplied to the engine, and wherein the data indicative of the set of manifold pressures correspond to historical data generated based on the first set of inputs and the second set of inputs;
obtaining a request to determine inlet manifold pressure at a desired engine speed and at a desired rate of fuel supplied to the engine; and
determining, based on the request, the inlet manifold pressure at the desired engine speed and at the desired rate of fuel supplied to the engine, interpolated from the 3D map.
